(19) United States
(12) Patent Application Publication
(10) Pub. No.: US 2025/0269564 A1
(43) Pub. Date: Aug. 28, 2025

(54) POROUS VACUUM MOLD FOR FFF/FDM PROCESSING

(71) Applicant: Addman Intermediate Holdings, LLC, Fort Myers, FL (US)

(72) Inventor: Daniel Saberton, Fort Myers, FL (US)

(21) Appl. No.: 19/063,493

(22) Filed: Feb. 26, 2025

Related U.S. Application Data
(60) Provisional application No. 63/557,824, filed on Feb. 26, 2024.

(51) Int. Cl. B29C 33/38; B33Y 80/00

(52) U.S. Cl. CPC B29C 33/3814; B33Y 80/00

(57) ABSTRACT

The present invention provides an additive manufactured vacuum mold for an FFF/FDM processing which includes a top surface, a bottom wall and side walls having a lattice grid disposed therewithin. A vacuum port enables a vacuum source to be applied to the mold. The lattice is a grid having layers formed therein in alternating directions on a layer-by-layer basis. The layers comprise strands or threads of infill material which are deposited or formed by additive manufacturing. Gaps are provided between the layers to enable a vacuum to draw material downward uniformly between the layers. A porous template seats upon the top wall to enable heated material to be drawn toward the top surface.

### CROSS-REFERENCE TO RELATED APPLICATION

This Application is a Completion Patent Application of co-pending U.S. Provisional Application Ser. No. 63/557,824 filed on Feb. 26, 2024, the disclosure of which is hereby incorporated by reference, including the drawing.

### PRIOR ART

As is known to those skilled in the art to which the present invention pertains Fused Filament Fabrication (FFF) or Fused Deposition Modeling (FDM) is a 3D-printing or additive manufacturing process that uses a continuous filament of a thermoplastic material. The filament is fed from a large spool onto or into a heated printer head wherefrom the heated filament is deposited onto a mold.

The printer head is moved by computer control to create the final printed shape. Ordinarily the head moves in two different axes, e.g., the X and Y axes, to deposit one horizontal bead or layer at a time. Once a layer is deposited, the printer head is then moved vertically, i.e., along the vertical Z-axis plane by an incremental amount and begins depositing a new layer along the X-Y plane.

Today, FFF printing is the most popular process for additive manufacturing because of the multitude of materials which can be used including ABS, PLA, PTG, PET, HIPS, TPU and various aliphatic polyamides, e.g., nylon, as well as carbon fiber, polyimides and the like.

This filament fabrication printing can be used with a wide variety of raw materials. It is also possible to use additive manufacturing with other materials including polymer matrix composites, ceramic slurries, clays, metals, food paste, biological material and as well as conductive polymer composites.

Not only can this process be used to create a part or object it can also be used to create a vacuum mold, itself, as discussed hereinbelow.

Although there are many ways of creating vacuum molds including sand printed molds the use of additive manufacturing offers distinct advantages since the parameters for creating the mold can be easily controlled.

However, the use of Computer Aided Design (CAD) for creating vacuum molds for use in vacuum thermoforming processes, the mold, itself, needs to be hollow with an outer shell of a specified thickness. The thickness of the shell must be sufficient to withstand the heat of the material to be formed as well as the vacuum to be applied which, in turn, is based on the thickness of the mold. Thus, materials such as polycarbonate including glass fiber-filled polycarbonate, as well as PEKK, PEEK and the like, can be used as mold material for higher temperature printing.

Also, it is to be appreciated that the utilization of vacuum thermoforming and the molds therefor need to be able to effectively print not only planar or flat objects but objects having angles as well as various thicknesses.

As disclosed hereinafter the present invention provides an improved vacuum mold for use in thermoforming additive manufacturing processes which effectively addresses these issues.

### BACKGROUND OF THE INVENTION

The present invention pertains to additive manufacturing processes. More particularly, the present invention concerns vacuum thermoforming using a 3D-printed vacuum mold. Even more particularly, the present invention concerns a 3D-printed vacuum mold for use with an FFF/FDM process.

### SUMMARY OF THE INVENTION

The present invention provides a vacuum mold for an FFF/FDM processing which includes a top wall, a bottom wall and side walls having a lattice grid disposed therewithin.

The lattice is a grid having layers formed therein in alternating directions on a layer-by-layer basis. The layers comprise strands or threads of infill material which are deposited or formed by additive manufacturing. A gap is provided between the layers.

A port having a plurality of openings is formed in the bottom or base of the mold to which a vacuum can be applied to draw material to be molded about the mold. The gaps between the layers enable the vacuum to be drawn and through which the vacuum source draws the material to be molded.

In a preferred embodiment, the mold has a multi-layered top surface and a shelf which may be printed with a porous or negative surface.

Preferably, the first two layers of the shelf are printed as porous surfaces if the features are for negative surfaces. Otherwise, the mold enables solid printing. The surfacing shelf, if positive surfaces are printed, has solid surfaces. Any surface can be porous or solid whether or not the surface is positive or negative.

For a more complete understanding of the present invention, reference is made to the following detailed description and accompanying drawing. In the drawing, like reference characters refer to like parts throughout the several views in which:

### BRIEF DESCRIPTION OF THE DRAWING

FIG. 1 is a partial, cut-away, perspective view of a vacuum forming mold in accordance with the present invention; and

FIG. 2 is a partial perspective view showing the vacuum port opening in the base of the mold;

FIG. 3 is an exploded view showing the sections or stages of the mold hereof;

FIG. 4 is a plan view showing an extruder depositing a layer for forming a vacuum mold in accordance herewith; and

FIG. 5 is a partial view showing an alternate embodiment hereof.

### DETAILED DESCRIPTION OF THE INVENTION

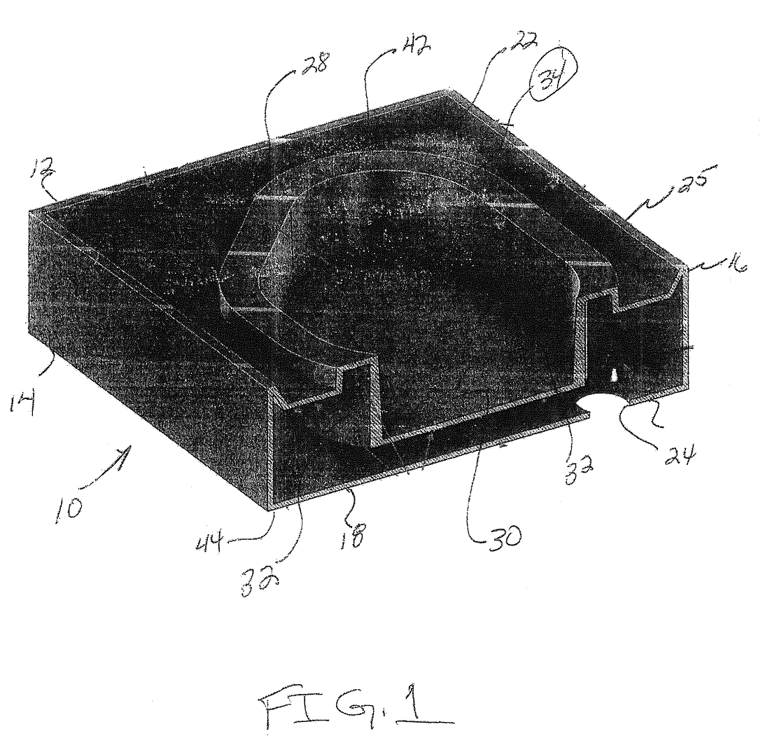

Referring now to the drawing and, in particular, FIGS. 1-4, there is depicted therein a mold in accordance with the present invention and, generally, denoted at 10. The mold 10, generally, comprises a bottom wall 18, a plurality of integrally formed sidewalls 12, 14, 16, and a front wall 19. The sidewalls terminate in an integrally formed perimetral edge 25.

The present mold as shown is an open top structure having a top upper or first surface 28. The top or first surface 28 is disposed below the edge 25 of the sidewalls of the mold.

The bottom wall 18 has a port 24 formed therein. Openings (not shown) to secure a vacuum source (not shown) to the mold about the port 24. The vacuum source is secured to the bottom wall 18 about the port 24 via the fasteners.

The port 24 has a plurality of apertures 27 which open to the interior 35 of the mold 10 and through which the vacuum source draws the material to be molded.

The interior of the mold is defined by a grid 36 having a plurality of layers 37, 38 etc. arrayed in alternating directions, including being perpendicular to each other with respect to adjacent layers.

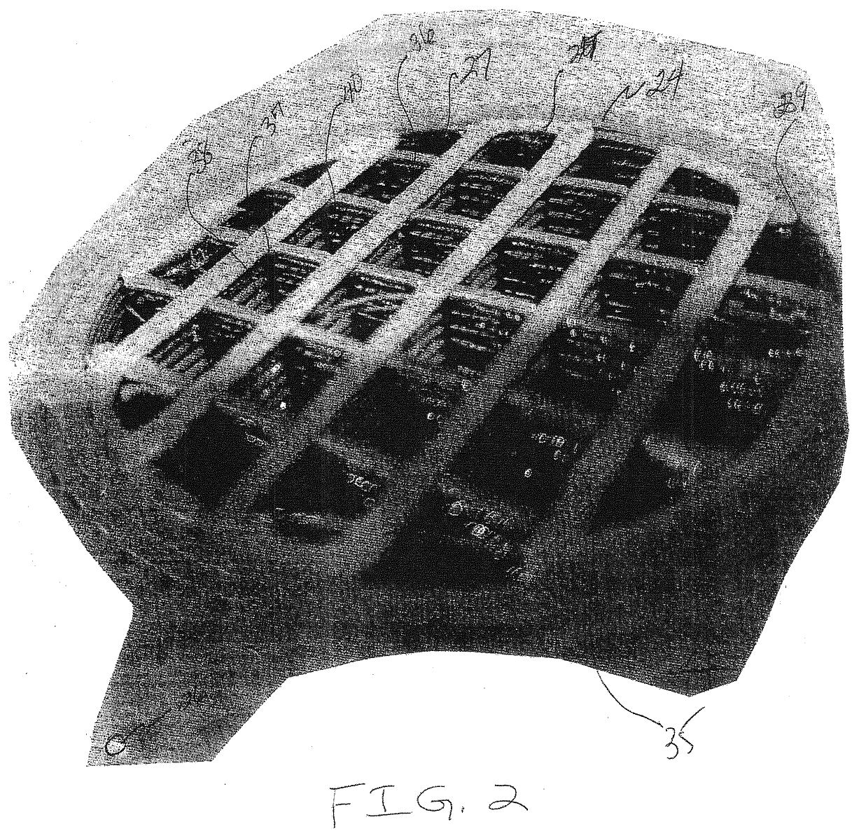

It is to be understood that lattice structures may comprise any suitable shape or pattern. Thus, any configuration of breathable lattice structure may be used herein in addition to the rectilinear lattice structure shown in FIG. 2.

The interior grid support or lattice material comprises any suitable infill material such as ABS, ASA, PLA, PETG, polypropylene, TPU, nylon, polycarbonate, PSU, PPSU, PESU, PEI, PEKK, PEEK, as well as metals, ceramics, sand or cement. Other useful infill includes, for example, carbon fiber, glass fiber, wood fiber. The infill can comprise short fibers, as well as, long fibers, whether milled or not, and the like.

Gaps 40 are provided between the layers to enable the vacuum to draw the material to be molded onto the mold exterior. The gaps 40 between each layer in the support or lattice material to enable air flow therethrough.

As shown, a template 42 for a part to be molded is fixedly disposed substantially centrally of the top surface 28.

The top surface 28 may comprise a porous recess or shelf 30. The recess 30 is shown coplanar with the top surface 28, but can be below or above, as well.

A perimetral wall or surface 32, which defines an outline of the template 42, includes a top surface 34, and bounds the shelf surface and projects thereabove.

In the embodiment depicted herein, the top surface 34 of the template 42 is a non-porous or solid surface as is the upper perimeter edge 25 of the mold itself, as noted hereinabove. The top surface 34 defines the configuration of the object to be molded. Although the mold defined herein has a non-porous or solid top surface and perimetral edge, depending on the configuration of the mold and the object to be molded, each surface can be either porous or solid.

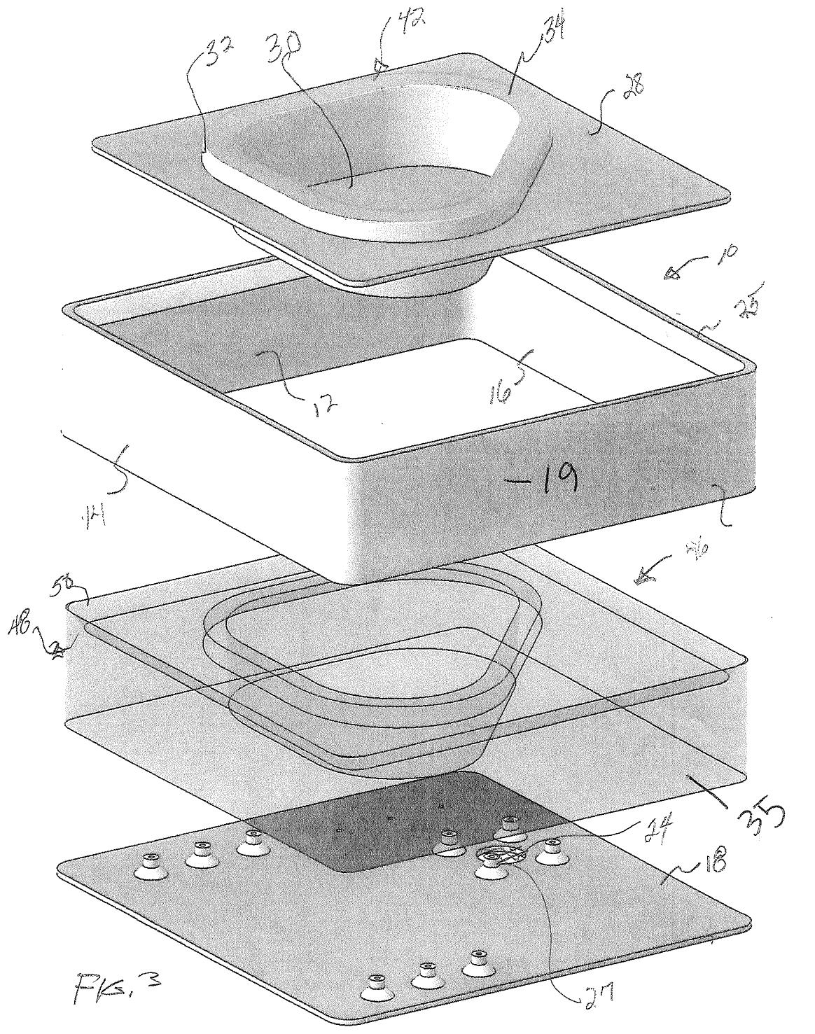

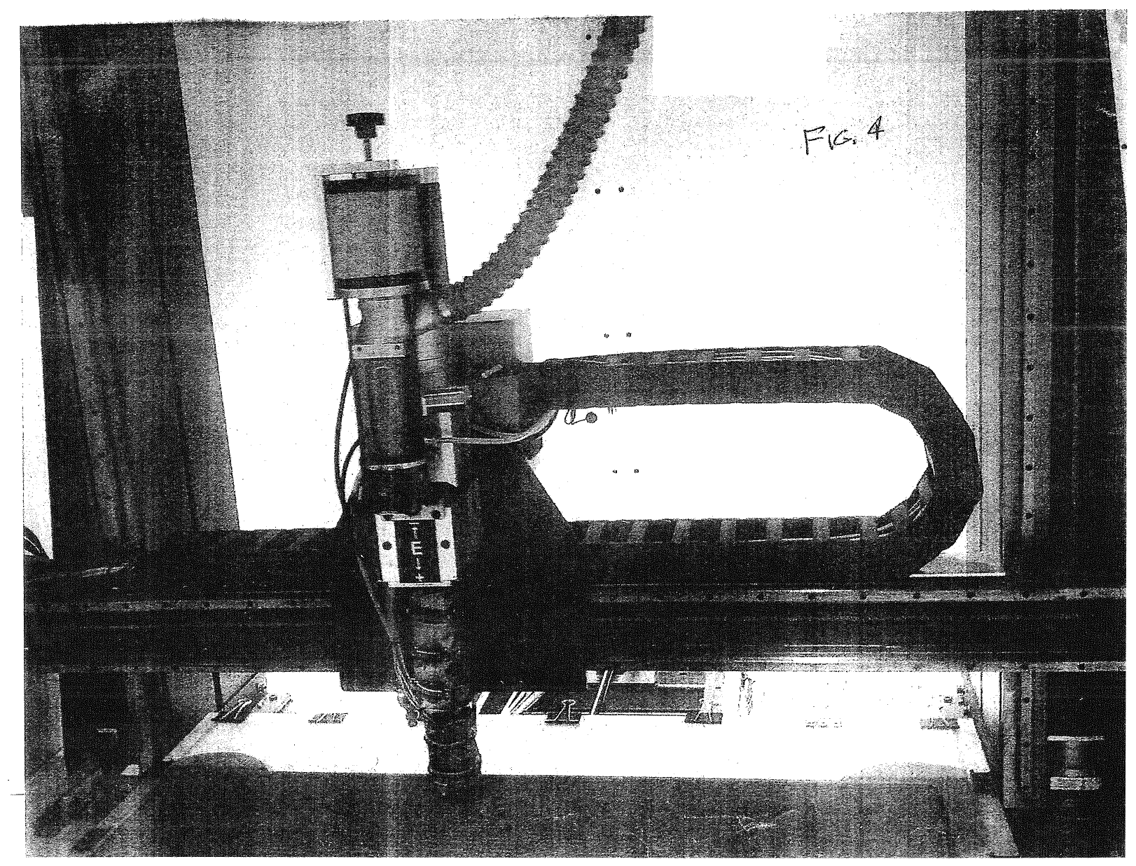

Referring now particularly to FIGS. 3 and 4, in manufacturing the mold by additive manufacturing, the bottom wall which comprises a solid platform is formed from any of the heretofore identified materials, e.g., carbon fiber, glass fiber-filled polycarbonate, etc. Here, the mold is created first by printing the bottom wall or base 18 via an extruder 60, having a nozzle 62. Ordinarily the bottom wall comprises at least about three non-porous layers of material to ensure a sealed vacuum can be achieved, although lesser or more layers may be used.

The mold further comprises a mid-or medial section 46.

The mold also includes an upper portion 48 of the midsection 46 and comprises a substantially dense support layer(s) 50 comprising multiple, individual, deposited infill which is deposited or extruded and deposited onto the medial section. The layer 50, preferably, comprises from about 75% to about 95% of the infill used to prepare the grid to ensure that this layer is not totally dense or solid. Suitable infill for use here includes the same materials enumerated above.

As noted hereinabove, the top surface 28 and shelf 30 are printed with porous or negative surfaces. The first two layers, preferably, are printed as porous surfaces if the features are for negative surfaces. Otherwise, they are printed solid. Again, rectilinear infill in alternating directions for each layer is used until the print reaches the top surface 28 and shelf 30. If the surface 28 and shelf 30 are positive surfaces they are printed as solid.

Preferably, the porous surface is created manually by using sparse infill with a defined percentage of infill which may range from about 50% to about 90% of the spacing as dictated by the slicer.

In use, the porous surfaces may be achieved through pre-determined proportional editing of the line width and extrusion factor via a slicer.

With most slicers or slicer software the extrusion amount is automatically increased in the background calculation when the line width is increased in order to achieve a print bead wide enough for the defined line width.

Aside from editing or controlling the amount of the infill percentage, the porous surface can be achieved via an inverse proportion relationship to the line width, such that the amount of extrusion can remain the same while increasing the line width in order to obtain optimum extrusion for layer binding.

In using the mold, an extruded sheet is emplaced over the mold, a vacuum is applied, and the heated sheet is drawn down onto the shelf 30 and around the solid or non-porous perimeter 28 in the well-known manner.

In manufacturing the mold, itself, and as shown in FIG. 4, and as known to the skilled artisan a vertical extruder 110 is used where pellets are fed from a source 112 which is heated via a conduit 114 which delivers heated air and travels to a heated nozzle 116 wherefrom the extruded pellet is deposited in layers according to a pre-set computer control.

It should be noted that by using the extruder in 3 or 5 axes sweeps the present mold can produce curved, angled or other irregularly shaped surfaces, including domed surfaces.

Typical extruders, as contemplated for use herein are well known and commercially available, such as that sold by Titan Robotics, under the name The Atlas. These extruders are capable of moving in the x, y and z-axes to enable the creation of the interior lattice.

It should be noted that filaments of the same materials in lieu of pellets may be used herein. The filament would be fed to the extruder in a similar manner as that used when using filament.

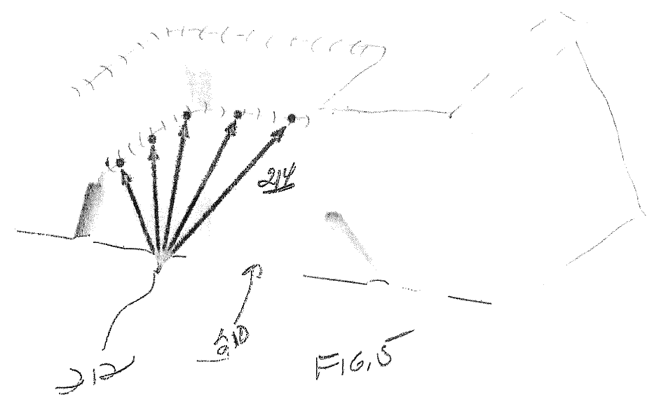

Referring now to FIG. 5 there is shown therein a mold configuration for printing non-planar objects which is used in drawing a vacuum, as described below, for thermoforming objects which may have curvilinear, angled or other irregular configurations other than a planar surface which does not allow for a porous surface.

As shown, a base 210 has an irregular configuration such as curvilinear, angled, domed or the like. In order to achieve the vacuum forming, a plurality of openings 212 are provided substantially at the corners of the top surface 214 of the mold which may be drilled or molded. These openings 212 enable the vacuum to draw material into the interior thereof and at the same time enable the forming of the object according to the desired geometry thereof.

Regardless of the configuration of the product or molded object, after cooling, the so-molded part is removed and is ready to be passed to a trimmer (not shown) where the final product is provided.

It should be noted that it is possible to deploy different materials with alternate extruders to create a mold out of multiple materials or to use an extruder of the type that has multiple material capabilities.

1. A vacuum mold for FFF/FDM processing, comprising:
(a) a bottom wall, sidewalls, and a front wall, the side walls extending upwardly from the bottom wall and terminating at a perimetral edge;
(b) a medial porous top surface deposited beneath the perimetral edge, the walls and top surface cooperating to create an open interior;
(c) a lattice formed in the mold interior, the lattice comprising a plurality of directional alternating layers having gaps between the layers; and
(d) a port provided in the bottom for securing a vacuum source thereto such that the vacuum draws material into the interior and wherein the top surface enables securement of a template for a part to be molded.

2. The mold of claim 1 wherein the mold is an additive manufactured mold.

3. The mold of claim 1 wherein the lattice is an infill grid.

4. The mold of claim 1 wherein the bottom wall comprises at least one solid layer of additive manufacturing deposited infill, the mold further comprising:
(a) a medial section overlying the bottom wall and having an upper portion comprising a dense support layer and which comprises from about 75% to 95% of the total infill used for the lattice; wherein further:
(b) the top surface overlying the medial section.
